(19) United States
(12) Patent Application Publication
(10) Pub. No.: US 2014/0229557 A1
(43) Pub. Date: Aug. 14, 2014

(54) Method and Apparatus for Intercarrier Chat Message Blacklist and Whitelist

(71) Applicant: INFINITE CONVERGENCE SOLUTIONS, INC, Arlington Heights, IL (US)

(72) Inventor: Geoffrey Dietz, Hoffman Estates, IL (US)

(73) Assignee: INFINITE CONVERGENCE SOLUTIONS, INC, Arlington Heights, IL (US)

(21) Appl. No.: 14/174,599

(22) Filed: Feb. 6, 2014

Related U.S. Application Data
(60) Provisional application No. 61/763,871, filed on Feb. 12, 2013.

(51) Int. Cl. H04L 12/58

(52) U.S. Cl. CPC H04L 51/24
USPC 709/206

(57) ABSTRACT

This invention relates to intercarrier chat blacklist or whitelist method as well as the message server which supports this method.

### CROSS-REFERENCE TO RELATED APPLICATIONS

This application claims the benefit of U.S. Provisional Application No. 61/763,871 filed on Feb. 12, 2013 by the present inventor. U.S. Provisional application No. 61/763,871 is incorporated by reference.

### FEDERALLY SPONSORED RESEARCH

None.

### SEQUENCE LISTING

None.

### FIELD OF THE INVENTION

This invention relates to blacklist and whitelist processing in Message Chat across multiple telecommunication carriers.

### BACKGROUND OF THE INVENTION

In intercarrier chat scenarios the Conference Factory Server controlling a chat session may very likely be in another carriers network. Also, for server based blacklists, it is common for only the local network elements to know the Blacklist for the local subscriber. There is no mechanism defined for transferring Blacklists between carriers and this action would require sharing of subscriber information between carriers which would be undesirable for privacy reasons. What is needed is a blacklist or whitelist method that is useable across telecommunication carriers where the blacklist or whitelist are maintained on the local providers servers. This is especially needed when new intercarrier users are added to an ongoing chat session.

In the preferred embodiment, during chat session setup, a SIP INVITE is normally sent from the Conference Factory Server in the foreign network to the local IM Server or other local network message server to connect a chat leg for a local subscriber to the foreign controlled chat session. The SIP INVITE contains a list of all chat session participants initially invited to the chat session and the originator of the chat session. At original setup time the local IM Server could validate the local subscriber Mobile Directory Number (MDN) including checking the provisioned Blacklist for the subscriber (this could also be a whitelist if supported and provisioned). Those skilled in the art will recognize that other local network elements besides the IM server such as Session Border Controller (SBC) element, or Interconnection Border Controller Function (IBCF) element could be used for this validation. Since the full participant list is included in the SIP INVITE, it is possible for the local network to validate the Blacklist for the subscriber before the chat session is connected to the local subscriber via the initial SIP INVITE.

The current art also allows users to be added to an ongoing chat session though the current art does not provide a mechanism for intercarrier blacklist or whitelist processing for users added to an ongoing chat session.

In the intercarrier SIP REFER scenario, which is used as the current art to add new participants to an existing chat session, another solution is needed. As per existing protocol, only the Conference Factory Server in the foreign network receives the SIP REFER and this message is not sent to all the chat session participants. The SIP REFER is the only message containing the new participant list for new chat session participants to invite to the chat session. So, under the current art, additional chat session participants join the chat session without any way for the local IM Server to check the local subscriber's Blacklist before the new session participants are invited to the chat session. This allows the blacklist or whitelist processing to be bypassed in this intercarrier scenario.

Under different current art, Blacklist validation may be also performed when chat payload is sent via MSRP SEND message. In this case the recipient list is not included in the message (MSRP Send) for ad-hoc and predefined group messages, but the sender address is included. So, Blacklist validation is only possible for the actual message originator and not for the other members of the chat. This type of Blacklist validation is currently available in the market but is not desirable since not all members of the chat are compared against the blacklist.

### SUMMARY OF INVENTION

The method is for a local message server, such as an Instant Message(IM) Server to intercept new user notifications (especially, but not limited to SIP NOTIFY messages) to determine if any new participants have been added to the chat session. The local apparatus can validate the Current participant list contained in each SIP NOTIFY message and then perform Blacklist (and/or Whitelist) validation for any new participants. It is expected that the local subscriber is removed from the chat session by the local IM Server when a new chat session participant is Blacklisted. Optionally, the local IM Server could just notify the local subscriber requesting further action to allow the local subscriber to then decide if they want to continue with the chat session. This method fixes the limitations of the SIP REFER message processing and allows the local IM Server to honor Blacklist provisioning to keep the local subscriber out of chat sessions with Blacklisted chatters. The local IM Server could also send a message to the local subscriber in the case when the local IM Server will remove them from the chat session. In this case the local IM Server also send SIP BYE to the foreign Conference Factory Server first to remove them from the chat session, and then send a system message to the local subscriber immediately before close their session with the local IM Server (via SIP BYE).

When the local chat session participant does not Subscribe for Notifications to the Conference Factory Server, the local IM Server should Subscribe on behalf of the local subscriber when the Blacklist (or Whitelist) is provisioned and not empty. In this case the local IM Server sends a SIP SUBSCRIBE to the Conference Factory Server in the foreign network as though the local subscriber originated the message. Since only the local IM Server requested the Notifications, SIP NOTIFY messages received for the session should not be forwarded to the local subscriber. If the local subscriber later attempts to Subscribe for Notifications, the local IM Server would just respond with success since a Subscription already exists and then forward any Notifications received. The local IM Server in this case would need to generate an initial SIP NOTIFY based on the last SIP NOTIFY received for the session. Optionally the SIP SUBSCRIBE from the local subscriber can still be forwarded directly to the Conference Factory Server, since this would just refresh the existing Subscription and require less processing at the local IM Server.

It may optionally be desired to only validate System Blacklist (and/or Whitelists) as participants join a chat session and not when the session is setup, since not all invited participants may join the session. In this case Blacklist processing could be skipped at SIP INVITE time and the using the method in this invention intercept Notification messages for session as new participants join the session to perform Blacklist validation at that time. This would also be a more efficient way to perform blacklist processing since only the actual participants in the session, instead of all invited participants would need to be processed.

### DRAWINGS

### Drawings—List of Reference Numbers

110 Mobile device “Mobile 2” in use by a subscriber in a local carrier network.
120 Generic Call Session Control Function device in local carrier network
130 Instant Message Server which consists of multiple logical functions including an Originating Participating Function, a Terminating Participating Function and a Controlling Function as per industry
140 Telecommunication Carrier logical boundary
150 Conference Server in foreign carrier network
160 Mobile device “Mobile 1” used by a subscriber in foreign carrier network
Note: Mobile devices “Mobile 3” and “Mobile 4” both based in foreign carrier network are not shown on diagram for simplification.

### GLOSSARY

Blacklist A group of one or more senders that are not allowed to send messages to a user or group of users.

### CONFERENCE FACTORY SERVER

A conference server implementation as described in IETF RFC 4579.
Foreign Not controlled by local telecommunications carrier.
IETF Internet Engineering Task Force
IM Instant Message
IM Server Instant Message Server which may include one or multiple logical functions including an Originating Participating Function, a Terminating Participating Function or a User Plane Function as described in ‘OMA Instant Message using SIMPLE’ specifications.
IP Internet Protocol
MDN Mobile Directory Number
OMA Open Mobile Alliance
RFC Request for Comments Document
SBC Session Border Controller
SIMPLE A methodology and set of extensions to SIP supporting the Instant Messaging requirements defined by IETF.
SIP Session Initiation Protocol
Subscriber An end user of telecommunications services
WHITELIST A group of one or more senders that are allowed to send messages to a user or group of users.
X-CSCF A generic Call Session Control Function which could include an Interrogating Call Session Control Function (I-CSCF) a Proxy Call Session Control Function (P-CSCF) or a Serving Call Session Control Function (S-CSCF)

### BRIEF DESCRIPTION OF DRAWINGS

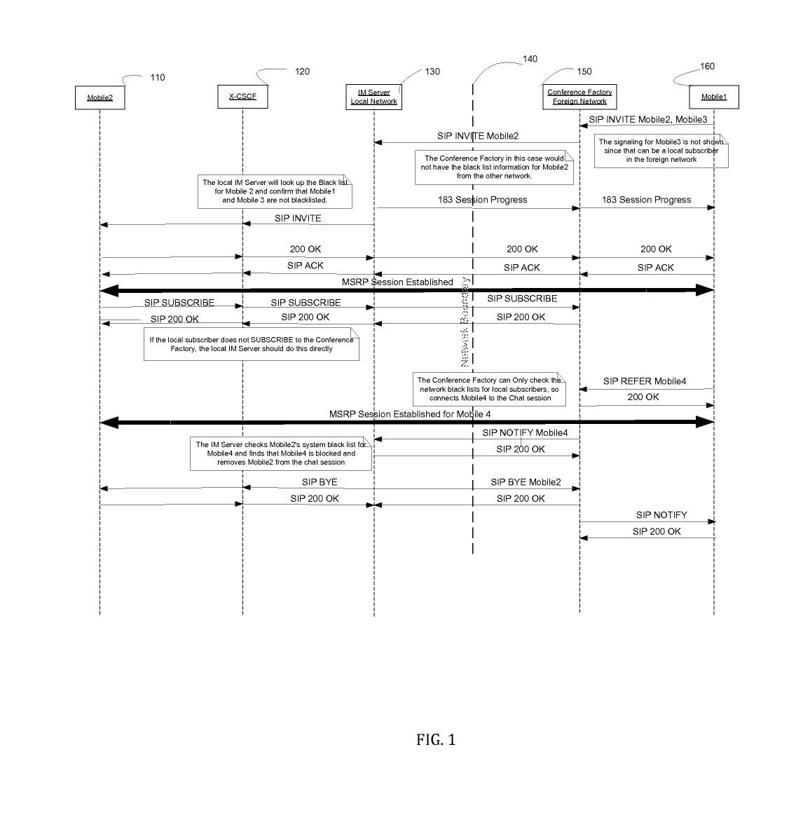

FIG. 1 shows Mobile 2 in the local network being initially invited to a group chat involving Mobile 1 and Mobile 3 in another carriers network. Mobile 1 and Mobile 3 are both listed in the contents of SIP_Invite and compared against Mobile 2's blacklist. Both subscribers are permitted and the group chat continues. Later in the group chat, Mobile 1 in the other carriers network invites Mobile 4 to the chat via SIP_REFER to the Conference Factory Server in the foreign network. The instant message (IM) Server in the local network receives a SIP_Notify (containing information about Moible 4) from the Conference server. The local IM Server determines that Mobile 4 is contained in Mobile 2's Blacklist. The local IM Server then issues a BYE message to the Conference Server and to Mobile 2 removing Mobile 2 from the group chat.

### DETAILED DESCRIPTION

In the current art, only the Conference Factory Server in the network receives the SIP REFER and this message is not sent to the chat session participants. Often the conference Factory Server is controlled by a different carrier than the one used by a local subscriber. The SIP REFER is the only message .containing the new participant list for new chat session participants to invite to the chat session. So, under the current art, additional chat session participants start joining the chat session without any way for the local IM Server to check the local subscriber's Blacklist before the new session participants are invited to the chat session.

All chat clients should then Subscribe (via SIP SUBSCRIBE) to Conference Factory Server for the chat session to be Notified (via SIP NOTIFY) as new participants join the chat session. This is the only way for a chat client to know all of the active session participants that are receiving messages for the session.

The new method is for the local IM or other Server to intercept these Notifications (e.g. SIP NOTIFY messages) to determine if any new participants since the original SIP INVITE have been added to the chat session. The local IM Server can validate the current participant list contained in each SIP NOTIFY message to the original list included in the SIP INVITE and then perform Blacklist (and/or Whitelist) validation for any new participants. It is expected that the local subscriber is removed from the chat session by the local IM Server when a new chat session participant is Blacklisted. Optionally, the local Server could just notify the local subscriber with the recommended action via a canned chat session message to the subscriber (a local IM Server initiated message to only the local subscriber). This method fixes the limitations of the SIP protocol SIP REFER message processing and allows the local Server to honor Blacklist provisioning to keep the local subscriber out of chat sessions with Blacklisted members. The local IM Server could also send a system message to the local subscriber in the case when the local Server will remove them from the chat session. In this case the local IM Server can send SIP BYE to the foreign Conference Factory Server first to remove them from the chat session, and then send a system message to the local subscriber immediately before close their session with the local IM Server (via SIP BYE).

When the local chat session participant does not Subscribe for Notifications to the Conference Factory Server, the local IM Server should Subscribe on behalf of the local subscriber when the Blacklist (or Whitelist) is provisioned and not empty. In this case the local IM Server sends a SIP SUBSCRIBE to the Conference Factory Server in the foreign network as though the local subscriber originated the message. Since only the local IM Server requested the Notifications, SIP NOTIFY messages received for the session should not be forwarded to the local subscriber. If the local subscriber later attempts to Subscribe for Notifications, the local IM Server would just respond with success since a Subscription already exists and then forward any Notifications received. The local IM Server in this case would need to generate an initial SIP NOTIFY based on the last SIP NOTIFY received for the session. Optionally the SIP SUBSCRIBE from the local subscriber can still be forwarded directly to the Conference Factory Server, since this would just refresh the existing Subscription and require less processing at the local IM Server.

Also, it may optionally be desired to only validate System Blacklist (and/or Whitelists) as participants join a chat session and not when the session is setup, since not all invited participants may join the session. In this case Blacklist processing could be skipped at SIP INVITE time and the using the method in this invention intercept Notification messages for session as new participants join the session to perform Blacklist validation at that time.

What is claimed is:

1) A method to support blacklist or whitelist processing for intercarrier group chat messaging when new users are added to an ongoing group chat, comprising: a local message server receiving notification messages on behalf of one or more local subscribers from a intercarrier server during an ongoing group chat; the local message server then performing a blacklist or whitelist validation on an existing list on the local server; forwarding of the notification message to the local subscriber if the validation is successful.

2) The method of claim 1 where the notification message is a SIP NOTIFY message.

3) The method of claim 1 which further includes removal of the local recipient when the blacklist or whitelist validation is unsuccessful.

4) The method of claim 1 which further comprises notification to the local subscriber that the blacklist or whitelist validation was unsuccessful.

5) The method of claim 4 that further comprises the step of requesting a decision from the subscriber to continue in the chat session after notification to the local subscriber of the failure.

6) A message server comprising a means to accept group chat invitation messages from a intercarrier server for an ongoing inter-carrier chat session and a means to perform blacklist or whitelist processing on newly added members of an ongoing chat session.

7) The message server of claim 6 where the invitation notification message comprises a SIP NOTIFY message.

8) The message server of claim 6 which also comprises a means to forwarding a new user notification messages received during an ongoing chat session from the inter-carrier server to the local client.

9) The message server of claim 6 which comprises a means to remove a local recipient from the group chat if any of the added users are considered blacklisted.

10) The message server of claim 6 which comprises a means to remove the local recipient from the group chat if any of the added users are not included in a nonempty whitelist.

11) The message server of claim 6 where the local message server comprises a part of a Interconnection Border Controller Function (IBCF).

12) The message server of claim 6 where the local message server comprises a part of a Session Border Controller (SBC).
